(19) United States
(12) Patent Application Publication
(10) Pub. No.: US 2023/0193807 A1
(43) Pub. Date: Jun. 22, 2023

(54) OBD SENSOR RESPONSE DIAGNOSTICS AND ANTI TAMPER DEVICE

(71) Applicant: DAF Trucks N.V., Eindhoven (NL)

(72) Inventor: Petter SMIT, Petrópolis (BR)

(21) Appl. No.: 17/512,840

(22) PCT Filed: Apr. 29, 2020
(86) PCT No.: PCT/NL2020/050267

§ 371 Date: Oct. 28, 2021

(30) Foreign Application Priority Data
Apr. 29, 2019 (NL) NL2023020

(51) Int. Cl. F01N 11/00

(52) U.S. Cl. CPC F01N 11/007; F01N 2560/026; F01N 2560/025

(57) ABSTRACT

A diagnostic method is provided for testing a gas sensor mounted in an exhaust gas stream of an internal combustion engine provided with an after treatment system and a diagnostic motor management module. The method comprises receiving a gas sensor signal from the gas sensor as subsequent gas sensor sample values in a time window; detecting a noise component from the gas sensor signal; deriving a sensor baseline condition in the diagnostic motor management module in case of a noise component detected at a value higher than a preset noise threshold value, and deriving a fault sensor condition in the diagnostic motor management module in case of a noise component detected at a value lower than the preset noise threshold value.

### BACKGROUND

In modern day diesel engines, measures are taken to minimize fuel consumption and harmful emissions. The emissions of diesel soot and NOx are reduced in the engine aftertreatment system (EAS) by respectively a diesel particulate filter and SCR catalyst. The diesel particulate filter collects soot while NOx typically reacts on the SCR (Selective Catalytic Reduction) catalyst with ammonia (formed out of injected urea) into harmless products also known as the deNOx process.

For this process it is important that measurements are carried out with a sufficient fast response time to regulate the after treatment system, notably, for actual and adequate dosing of urea. This disclosure pertains to on-vehicle testing methods to assess electrical output signals from gas sensors placed in diesel engine (or other lean-burn engine) exhaust gas streams to detect amounts of gas content such as oxygen, or nitrogen oxides (NOx) in the exhausts. Such concentration-related, voltage or current signals are used by on-vehicle computer-based control systems for management of engine operation, and for management and assessment of engine exhaust treatment.

SCR-type exhaust after-treatment systems may require NOx sensors that are inserted in the exhaust stream for use in managing the addition of the reductant material to the exhaust stream and other after-treatment practices. NOx sensors are often formed as small electrochemical cells that function, for example, by producing voltage or electrical current signals responsive to the amount of nitrogen oxide species flowing in the exhaust and over sensor surfaces. NOx sensor data may be also used in assessing whether catalysts for NOx reduction, or other exhaust after-treatment materials, are working properly. Another sensor that provides relevant process information on the engine state and after treatment state is an oxygen sensor that may be used to regulate the exhaust gas recirculation system and after treatment system.

A soot filter becomes loaded with soot after a certain time of engine running and needs to be cleaned through active regeneration. In addition the sensors, in particular, the NOx or O2 sensors may become loaded with soot, which may affect the proper functioning thereof, in particular, the response times, since the sensor surfaces may become polluted or free access to the sensor surface of exhaust gas may become blocked. A possible way to detect faulty behaviour of a gas sensor is to match the sensor data to a predictive model that is used for predicting gas emission values. This can be modelled in various known ways, e.g. by monitoring engine state values, such as air mass transport, oxygen content, fuel use and other engine parameters. US20120255277 proposes an in-vehicle system for determining a proper functioning of the NOx sensor. The sensor compares a NOx sensor variance based on a variance of the fuel flow. However, a more direct way of measuring the NOx data and estimating the reliability is not presently known. There is still the need for a fast model free type of diagnostic sensor monitoring. In addition to sensor diagnostic fault detection, there is a further need for a diagnostic analysis of the engine since it has to be tested if the sensor is not tampered. In known cases, sensor values may be replaced by simulated false values in order to fool the motor diagnostics and prevent the engine response of the motor management system, e.g. when an EGR valve is welded shut and a urea dosing is no longer used.

### SUMMARY

It is an aspect of the present invention to alleviate, at least partially, the problems discussed above. A diagnostic method is provided for testing a gas sensor mounted in an exhaust gas stream of an internal combustion engine provided with an after treatment system and a diagnostic motor management module. The method comprises receiving a gas sensor signal from the gas sensor as subsequent sensor sample values in a time window and detecting a noise component from the sensor signal. A sensor OK condition is derived in the diagnostic motor management module in case of a noise component detected at a value higher than a preset noise threshold value, and a fault sensor condition is derived in the diagnostic motor management module in case of a noise component detected at a value lower than the preset noise threshold value.

The inventors found that the presence of a noise component with a value higher than a noise threshold value relates to a condition where the sensor is able to measure gas concentration fluctuations, in the remainder indicated as ‘noise’, that naturally arise in the motor e.g. from valve timing and exhaust micro turbulence phenomena. Other factors that may amount to variance, which amounts to a noisy sensor signal, may be due to uncontrolled factors influencing the measured quantity, such as aerodynamic effects, e.g. turbulence (caused, for example, by the presence of a physical sensor in the flow) vorticity, boundary layer effects, imperfectly controlled combustion in the cylinders etc. The operating conditions of a gas sensor (engine out) are thus volatile and fluctuate rapidly and unpredictably due to many uncontrolled effects in both combustion and aerodynamics. When the sensor is too slow due to multiple failure modes, these fast, unpredictable effects can no longer be detected by the sensor because they are filtered out by the failure mode. The technology measures the high frequency components in the signal and compares this to an expected high frequency energy component in an active engine. If the high frequency energy component is too low, this is a good indicator that the sensor has been slowed down due to some kind of failure mode. Accordingly a detection mechanism for a slow responding gas sensor or a tampered sensor signal can be provided.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 shows a schematic representation of an internal combustion engine and after treatment system and shows a possible NOx sensor position in the exhaust;

FIG. 2a shows a sensor signal with a high noise component value;

FIG. 2b shows a sensor signal with a low noise component value;

FIG. 3 shows a first noise component detection scheme;

FIG. 4 (A+B) shows normalized graph for identifying sensor baseline sensor conditions and sensor fault conditions;

FIG. 5 shows another noise component detection scheme;

FIG. 6 shows another normalized graph for identifying sensor baseline sensor conditions and sensor fault conditions;

FIG. 7 shows an integral error of NOx sensor values;

FIG. 8 shows an example flow diagram for a diagnostic decision method.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Unless otherwise defined, all terms (including technical and scientific terms) used herein have the same meaning as commonly understood by one of ordinary skill in the art to which this invention belongs as read in the context of the description and drawings. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some instances, detailed descriptions of well-known devices and methods may be omitted so as not to obscure the description of the present systems and methods. The term “and/or” includes any and all combinations of one or more of the associated listed items. It will be further understood that the terms “comprises” and/or “comprising” specify the presence of stated features but do not preclude the presence or addition of one or more other features. All publications, patent applications, patents, and other references mentioned herein are incorporated by reference in their entirety. In case of conflict, the present specification, including definitions, will control.

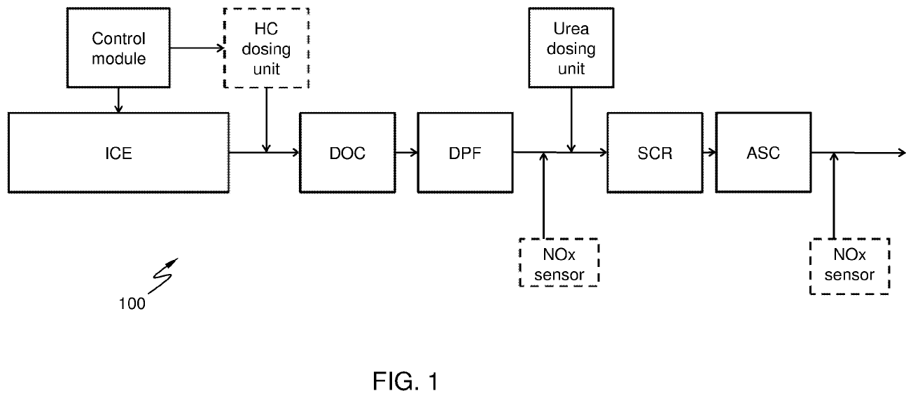

FIG. 1 given as a simplified schematic representation of a system setup 100 of an internal combustion engine (ICE) and a typical aftertreatment system (EAS). The EAS system may comprise a hydrocarbon (HC) dosing unit, a Diesel Oxidation Catalyst (DOC), a Diesel Particulate Filter (DPF), a Urea dosing unit, a Selective Catalytic Reduction catalyst (SCR), an Ammonia Slip Catalyst (ASC) and a Control Module (CM) placed downstream of the ICE (internal combustion engine) including a turbo compressor. This setup is conventional, in the sense that the system elements are known to the skilled person. The exhaust stream from a diesel engine may contain, by volume, up to about ten percent of oxygen, about 100 to 2000 parts-per million (ppm) of nitrogen oxide (NO), and about 20-200 ppm of nitrogen dioxide (NO2). To analyse the NOx content, a NOx sensor can be employed at a predetermined location in the exhaust stream to quickly determine current quantities of NOx constituents for determining, for example, how much reductant material should be currently added to affect conversion of the NOx to nitrogen and water. In such case, the sensor would be located upstream of a reductant material injection device and of an SCR catalyst material. Alternatively or additionally, a NOx sensor may be located downstream of an SCR catalyst material, in the flow of the exhaust stream, to confirm the reduction of the NOx or raise an alarm condition to a diagnostic system when this is working insufficiently. In FIG. 1 the NOx sensor as indicated may not necessarily be at the indicated position but also other sensor positions in the system may be useful for measuring engine or aftertreatment performance. In addition, in addition to a NOx sensor, other sensors may be used, for example flow sensors, chemical substance sensors, etc., that can indicate whether the aftertreatment system is affected by degradation. A typical, but not essential aspect of the aftertreatment system for this invention is a HC dosing unit, that may inject fuel in the exhaust. The fuel oxidizes over the DOC and leads to a temperature increase of the exhaust gas downstream the DOC due to the exothermal reaction. As an alternative, fuel can be injected via a late post injection system in the cylinder—injecting fuel in the exhaust without igniting it in the cylinder—or the ICE can operate with higher engine out exhaust gas temperatures.

The engine out NOx sensor is mounted in the exhaust manifold and measures the NOx concentration (as well as O2 concentration) which is controlled by the engine controls by the engine mode it is operating in. This means that this sensor is used indicatively for the control of NOx out of the system, and therefore for the dosing of DEF, which implies the functioning of part of the EAS.

The exhaust manifold is a volatile environment. It is subject to multiple influences via the combustion process and the three local actuators VGT, BPV and EGR valves. This makes for a complex environment of which the NOx output is captured in the NOx model (engine out NOx estimator). Due to the complexity of the system, this model is frequently not accurate, especially when the conditions are transient. The diagnostic for which this concept was developed is a transient diagnostic, and therefore the reduction of dependence on the model is desired.

By using a method which is completely independent of modelling, an additional layer of certainty is added to the diagnostic for slow sensors operating in naturally volatile environments. When a failure mode results in a sensor which behaves as if filtered, the noise or noise-like behaviour on the sensor output can be measured and used as a diagnostic feature. The inventive diagnostic method relies on deriving a sensor baseline condition in the diagnostic motor management module in case that a noise component is detected at a value higher than a preset noise threshold value. A sensor fault condition is flagged in the diagnostic motor management module in case of a noise component detected at a value lower than the preset noise threshold value. Improving on board diagnostic monitors like this improves lamp on time, diagnostic accuracy and can be applied to multiple sensor types.

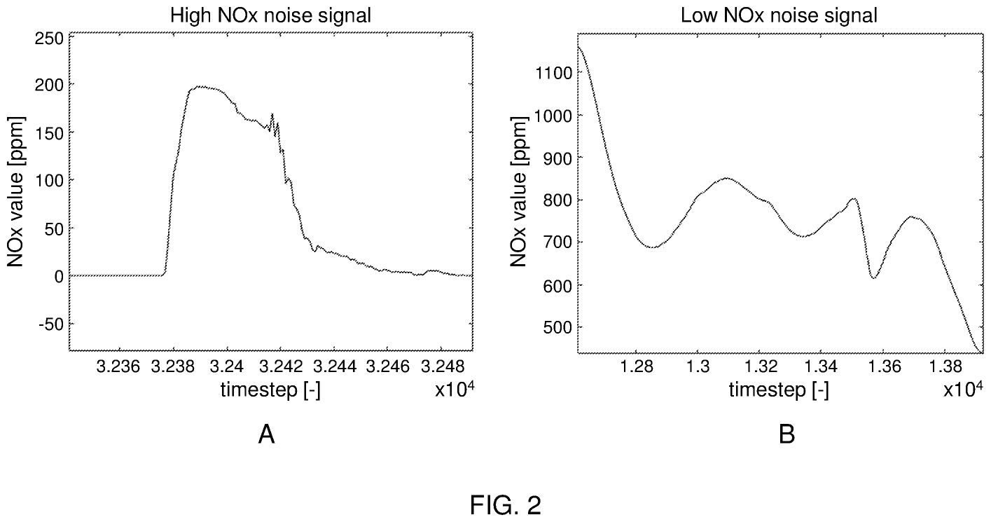

The technology may be a diagnostic detection mechanism for a slow responding or tampered sensor. For example, for an NOx sensor, operating conditions of the sensor (engine out) are volatile and fluctuate rapidly and unpredictably due to many uncontrolled effects in both combustion and aerodynamics, that appear as a noisy signal component in the NOx sensor signal. It is appreciated, that the term ‘noise’ here reflects measurements of a physical system on a much shorter timescale than the conventional timescale wherein the sensor is used for its monitoring purpose. Typically for monitoring purposes, these are timescales larger than 250 milliseconds or even larger than 500 milliseconds, whereas a noise component is detected from irregular variations in the NOx sensor sample values in a time window ranging between 150 and 350 milliseconds that is, typically below 500 milliseconds. In accordance with Nyqvist criteria, maximum sensor sample time intervals may be about 100 milliseconds to detect a noisy component, preferably sensor sample values are taken at intervals between 10 and 100 milliseconds, e.g. 50 milliseconds. An example of a NOx sensor signal with a high noise component value and a NOx sensor signal with a low noise component value is shown in FIGS. 2a and 2b respectively. It can be seen, in comparison, that FIG. 2b, by a slow response which may be due to multiple failure modes, these fast, unpredictable effects are no longer be detected by the NOx sensor because they are filtered out by the failure mode. The technology measures the noise component in the NOx signal and compares this to an expected noise component in an active engine. If the noise is too low, this is a good indicator that the sensor has been slowed down due to some kind of failure mode.

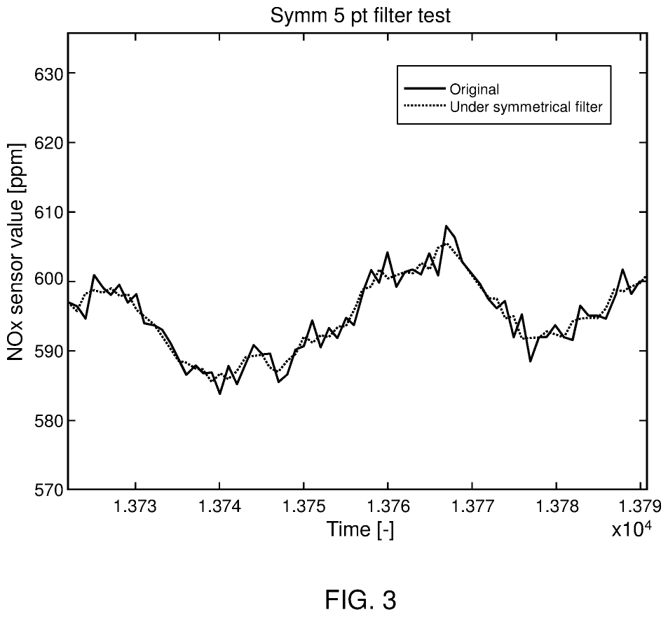

FIG. 3 shows a first noise component detection scheme where the noise component is calculated from a difference between the NOx sensor sample values and a moving average filtered signal value for the aligned filtered signal and the actual, unfiltered NOx sample data. In the Figure, as an example, this filtered signal value is derived from a so called 5 points symmetrical filter which is a software-based method known in the art to measure a signal smoothness from a raw signal. Other filter methods can be non-symmetrical filters, and filters that use more (or less) than five sample values for the moving average value. E.g. the moving average filtered signal value may be calculated over 3-8, preferably five subsequent NOx sensor sample values of NOx sensor samples taken at 10-100 ms, preferably 40-60 milliseconds. The noise component that can be detected in the NOx sensor signal can be expressed as the error value or difference between these filtered and unfiltered traces. This component represents the aggregated effect of the uncontrolled variance and is the inverse of the signal smoothness. Based on the signal smoothness, an evaluation can be made with respect to the response speed of the sensor. A healthy sensor will respond to the effects of the uncontrolled variance by containing a high error value at many points (in particular when the system is going through a state change, such as a transient event (when the load on the engine is significantly increased or decreased) in the case of the engine out NOx value), whereas a slow sensor (whatever the reason for this slow-ness, such as clogging or poisoning), will show almost no difference between the aligned filter value and the original sensor trace, and therefore will have a smooth signal.

Detection of a failed sensor then occurs by comparing the measured effect of the uncontrolled factors (error between aligned filter trace and actual NOx sample trace) against the expected measured effect of the uncontrolled factors.

Depending on the normal speed of the sensor and the expected timespan and interaction durations of the uncontrolled factors, the filter constants or moving averaging time spans can be tuned in order to isolate and/or maximize the effects of the uncontrolled factors.

An advantage of looking at the signal smoothness as compared to the traditional approach of doing frequency analysis is that the system trends are automatically removed due to the aligned filtering, which results in a vastly amplified and more specific value for the diagnostic quantity (effect of uncontrolled factors on the signal).

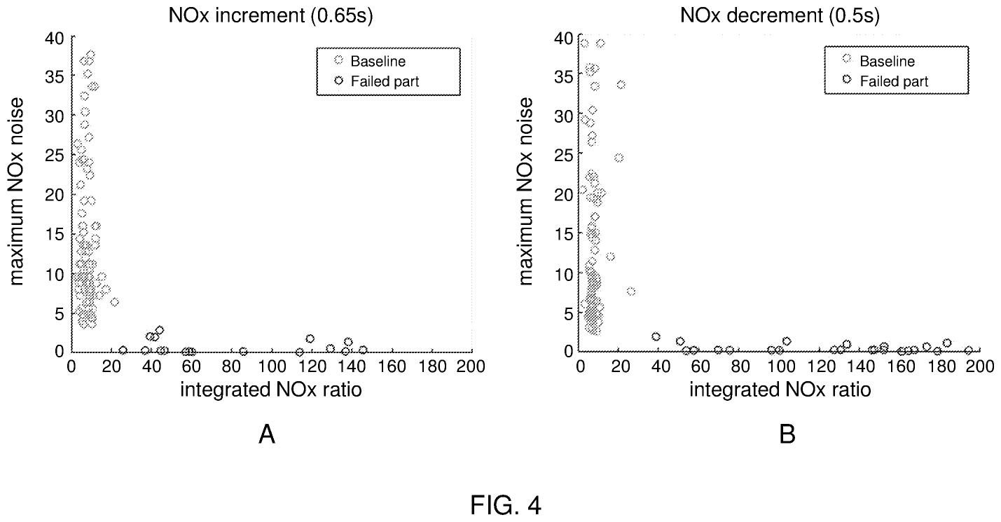

FIGS. 4a and 4b show normalized graphs for identifying sensor baseline sensor conditions and sensor fault conditions for the noise component detection scheme of FIG. 3. The graph shows for combining this concept of noise measuring with the conditions during which a dynamic response diagnostic usually runs (during times when the NOx signal is supposed to increase or decrease significantly) that the data points can be scattered as shown in FIGS. 4A and 4B.

By using the maximum noise value found (difference between instantaneous value and the filtered value), an instantaneous inversion of the direction of the signal is exacerbated, resulting in the largest separation between baseline sensor condition and sensor fault condition and can thus differentiate optimally. However, a noise component may also be derived from a signal to noise measurement of the NOx sensor signal. Examples can be determining e.g. integrated noise, minimum noise or average noise calculation methods. In an embodiment, following steps are taken:

1. Determine conditions under which the measured quantity is expected to be affected heavily by uncontrolled factors

2. Under conditions mentioned in 1., filter the raw signal to show the longer-term trends (such as actuated system state changes) and align this filtered signal to the raw signal

3. Calculate the difference between the raw and filtered signals as described in 2.

4. Over a set duration while the conditions described in 1. apply, process the error values described in 3. Examples of processing are: integrated error value over set duration, maximum error value over set duration, average value over set duration etc.

5. Compare the processed error value or values as described in 4. to a threshold which represents the expected processed error value (representing the signal roughness) which should have occurred during the set duration described in 4. If the signal roughness is too low, the sensor is evaluated as responding too slowly

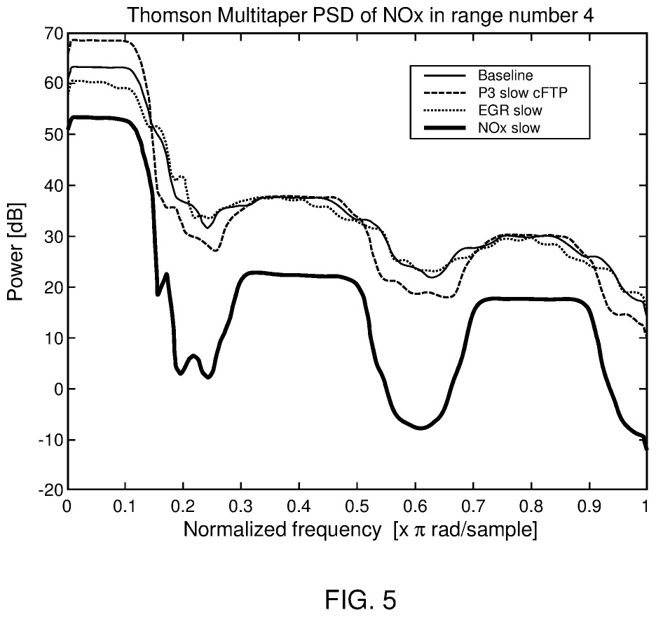

FIG. 5 shows another noise component detection scheme, where a sensor baseline condition can be derived in the diagnostic motor management module in case of a noise component detected at a value higher than a preset noise threshold value, and deriving a sensor fault condition in the diagnostic motor management module in case of a noise component detected at a value lower than the preset noise threshold value. Here the noise component may be derived from a frequency analysis of a NOx sensor signal by analyzing a power spectrum in the frequency domain. In particular, the noise component of a NOx sensor signal to be detected is high frequency power component, which may be compared to a baseline power signal that sets a preset noise threshold value. The method involves storing the raw signal output for a time when the sensor output is assumed to contain significant effects of uncontrolled factors, and then using a frequency domain transformation such as a fast-fourier transform (fft) in order to translate the raw signal to its power spectrum in the frequency domain. The timeframe during which data is to be collected depends on the nominal response speed of the system and how strongly the uncontrolled factors influence the measured quantity. In the example, the frequency analysis is derived from an example of the frequency-transformed NOx signal, using a Thomson multitaper power spectrum with a normalized frequency axis (horizontal axis). The transformation is a known fast signal processing method. The image shows data from four individual data points, during one of which a (slow) failed sensor was used. The lines show the power at the indicated frequencies.

Based on the difference in power spectrum between the healthy and failed sensor-containing systems, an evaluation of the sensor response speed can be made. A healthy sensor will contain significantly more power in the higher frequency ranges than a slow sensor, especially at frequencies above the limit of the controlled factors (typically system actuators and their speed of change). There will also be a bandwidth at which the innate sensor signal will be noisy; this can vary greatly depending on the type of sensor used.

The evaluation will be made in a certain bandwidth, depending on the system, where the difference between a slow and healthy sensor are largest. For example, the integrated power over a certain bandwidth can be calculated and compared to an expected threshold value.

Depending on the normal speed of the sensor and the expected timespan and interaction durations of the uncontrolled factors, the length of time during which the raw signal must be stored for conversion and the bandwidth(s) at which the signal is compared to a threshold can be tuned in order to maximize the effect of the uncontrolled factors on the controlled signal.

The relative effect of the uncontrolled factors is particularly important in this method, as it relies on the difference between the base power (the slower measured quantity trends) and the added power due to the uncontrolled factors.

In an embodiment, following steps are taken:

1. Determine conditions under which the measured quantity is expected to be affected heavily by uncontrolled factors

2. Under conditions mentioned in 1., store the raw sensor trace for a predetermined amount of time (for example, engine speed and fuel load based)

3. After the time mentioned in 2. is completed, transform the stored sensor trace mentioned in 2. to the frequency domain

4. Process the frequency domain representation of the data as described in 3. towards a final diagnostic variable (examples are the integrated power in a predetermined bandwidth, or a single power spectrum point at a frequency a normalized average of multiple frequencies etc.)

5. Compare the processed power described in 4. to an expected power value threshold (representing the power present in the total signal, including the uncontrolled variables). If the signal power is too low, the sensor is evaluated as responding too slowly

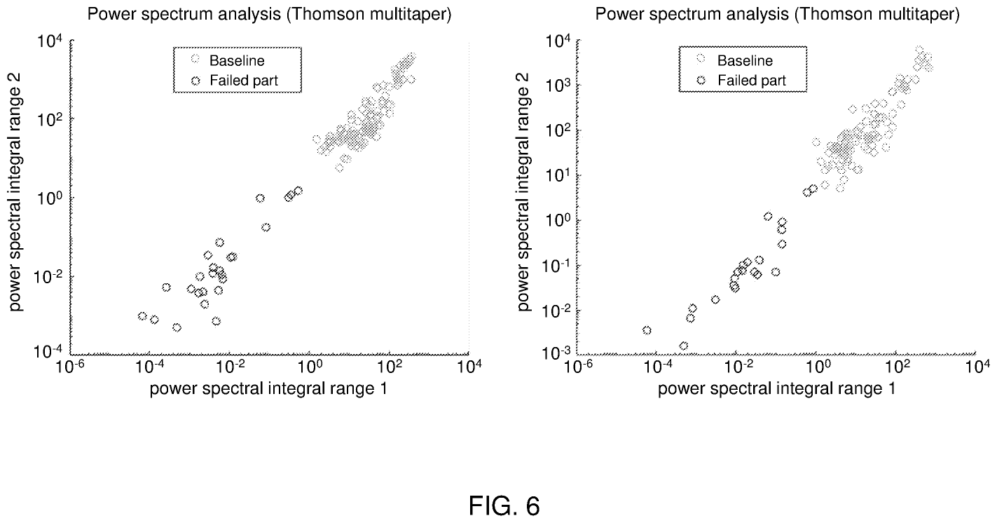

FIG. 6 shows another normalized graph for identifying sensor baseline sensor conditions and sensor fault conditions;

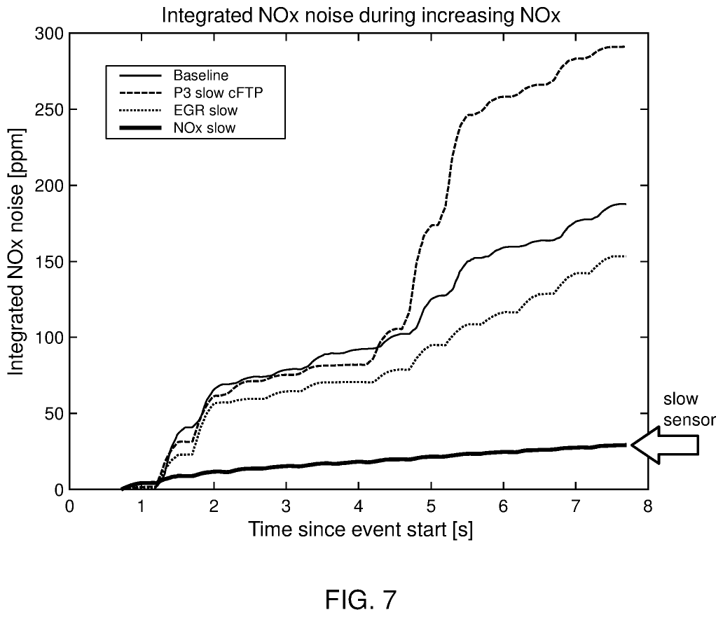

FIG. 7 shows an integral error graph of NOx sensor values for various sensor fault conditions. It is shown that the integrated error over time behaves substantially different for a failed NOx sensor, compared to other conditions that may contribute to an error component in the NOx signal. Accordingly, the noise component detection method is very robust for detecting a NOx sensor fault condition.

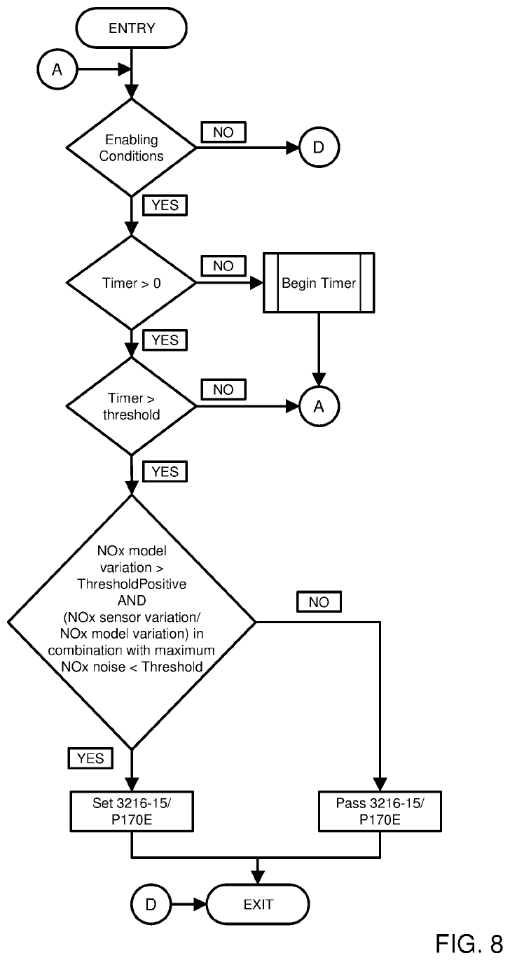

FIG. 8 shows an example flow diagram for a diagnostic decision method. In a first action A enabling conditions are determined under which the measured sensor signal is expected to be affected by uncontrolled factors resulting in a detectable noise component. In a further action a sensor signal trace is collected over a time window. The time window is sufficient to show the longer-term trends (such as actuated system state changes) and align this filtered signal to the raw signal. In certain ‘off line’ embodiments the sensor signal trace may be stored, for further transformation an calculation purposes, or for adjusting a noise threshold value and filter components to detect a suitable noise value. These thresholds may be dependent for example on engine speed or may be based on fuel load.

In a further action, if sufficient NOx sensor data are collected from the NOx sensor as subsequent NOx sensor sample values in a time window, a calculation can be started to detect a noise component from the NOx sensor signal and to derive a sensor baseline condition in the diagnostic motor management module in case of a noise component detected at a value higher than a preset noise threshold value, or, conversely, to derive a sensor fault condition in the diagnostic motor management module in case of a noise component detected at a value lower than the preset noise threshold value. For example, this can be realised, as set out here above, by calculating a difference between raw and filtered signals or by transforming the stored sensor trace mentioned to the frequency domain. In particular, over a set duration while the enabling conditions apply, error values can be detected such as an integrated error value over set duration, maximum error value over set duration, average value over set duration etc. Or, as set out earlier, a frequency domain representation of the data can be processed towards a final diagnostic variable (examples are the integrated power in a predetermined bandwidth, or a single power spectrum point at a frequency a normalized average of multiple frequencies etc.) In a further action the processed error value or values are compared to a threshold which represents the expected processed error value (representing the signal roughness) which should have occurred in the duration of the time window indicated earlier.

Another threshold comparison may be comparing the processed power to an expected power value threshold (representing the power present in the total signal, including the uncontrolled variables). In a further action, if the signal power is too low, the sensor is evaluated as responding too slowly (sensor fault condition) or the sensor is evaluated as a sensor baseline condition.

The same principle described in this document can be used to diagnose other gas sensors operating in volatile environments as long as their failure modes slow down the measured quantity significantly enough (as may not be the case for e.g. pressure sensors). An example of such a gas sensor is an engine out O2 sensor in particular, in case it may share hardware with the NOx sensor.

1. A diagnostic method for testing a gas sensor mounted in an exhaust gas stream of an internal combustion engine provided with an after treatment system and a diagnostic motor management module, the method comprising
receiving a gas sensor signal from the gas sensor;
detecting a noise component from the gas sensor signal;
deriving a sensor baseline condition in the diagnostic motor management module in case of a noise component detected at a value higher than a preset noise threshold value, and deriving a sensor fault condition in the diagnostic motor management module in case of a noise component detected at a value lower than the preset noise threshold value.

2. The diagnostic method according to claim 1, wherein the noise component is detected from variations in gas sensor sample values in a time window ranging between 150 and 350 milliseconds.

3. The diagnostic method according to claim 1, wherein the gas sensor signal is taken from sample values at intervals between 10 and 100 milliseconds.

4. The diagnostic method according to claim 1, wherein the noise component is calculated from a difference between the gas sensor signal value and a moving average filtered signal value.

5. The diagnostic method according to claim 4, wherein the moving average filtered signal value is calculated over 3-8 subsequent gas sensor sample values of gas sensor samples taken at 10-100 ms.

6. The diagnostic method according to claim 1, wherein the noise component is derived from a signal to noise measurement of the gas sensor signal.

7. The diagnostic method according to claim 1, wherein the noise component is derived from a frequency analysis of the gas sensor signal, wherein the noise component of the gas sensor signal is a detected high frequency power component.

8. The diagnostic method according to claim 7, wherein the frequency analysis is derived from a Thomson multitaper power spectrum transformed sensor signal.

9. The diagnostic method according to claim 1, wherein the sensor is an NOx sensor and the sensor signal is an NOx sensor signal.

10. The diagnostic method according to claim 9, wherein the gas sensor is provided upstream of an engine after treatment system.

11. The diagnostic method according to claim 9, wherein the gas sensor is provided downstream of an engine after treatment system.

12. The diagnostic method according to claim 1, wherein the sensor is an O2 sensor and the sensor signal is an O2 sensor signal.

13. The diagnostic method according to claim 5, wherein the moving average filtered signal value is calculated over 5 subsequent gas sensor sample values of gas sensor samples.

14. The diagnostic method according to claim 5, wherein the gas sensor samples are taken at 40-60 ms.
